(19) United States
(12) Patent Application Publication
(10) Pub. No.: US 2013/0017748 A1
(43) Pub. Date: Jan. 17, 2013

(54) POROUS SHEET AND METHOD FOR MANUFACTURING THE SAME

(71) Applicants: Jin Wook NA, Gyunggi-do (KR); Jae Sik RYOO, Gyunggi-do (KR); Jun Hwan YOO, Seoul (KR); Sun Ok KIM, Seoul (KR)

(72) Inventors: Jin Wook NA, Gyunggi-do (KR); Jae Sik RYOO, Gyunggi-do (KR); Jun Hwan YOO, Seoul (KR); Sun Ok KIM, Seoul (KR)

(73) Assignee: SAMSUNG ELECTRO-MECHANICS CO., LTD., Gyunggi-do (KR)

(21) Appl. No.: 13/332,519

(22) Filed: Dec. 21, 2011

(30) Foreign Application Priority Data
Jul. 15, 2011 (KR) 1020110070604

(51) Int. Cl. D04H 3/12; B32B 27/08; B32B 27/02; B32B 37/12; D04H 3/16

(52) U.S. Cl. 442/334; 264/425; 156/167; 442/327; 442/365

(57) ABSTRACT

Disclosed herein is a porous sheet, including a fine fiber web, wherein the fine fiber web is formed by bonding fine fibers with each other using an adhesive material.

### CROSS REFERENCE TO RELATED APPLICATION

This application claims the benefit of Korean Patent Application No. 10-2011-0070604, filed Jul. 15, 2011, entitled “Porous sheet and method for manufacturing the same”, which is hereby incorporated by reference in its entirety into this application.

### BACKGROUND OF THE INVENTION

1. Technical Field

The present invention relates to a porous sheet and a method of manufacturing the same.

2. Description of the Related Art

Generally, the exfoliation of a ceramic green sheet is done using vacuum force, and the peel force thereof is changed depending on the shape of the structure that can adsorb the ceramic green sheet in the vacuum.

Conventionally, a metal body or a metal sintered body having surface holes formed at the portion coming into contact with the ceramic green sheet has been used, or a metal plate having holes formed at regular intervals by etching has been used.

However, since a mold is made of the metal body, there are problems in that the contact portion of the ceramic green sheet is damaged, and in that the holes formed on the mold damage the ceramic green sheet.

When the surface of a ceramic green sheet used to manufacture a laminated ceramic condenser is damaged, the inner pattern formed on the surface of the ceramic green sheet is damaged, causing product defects, such as a short and the like, after the ceramic green sheets are stacked.

Therefore, research into porous adsorptive sheets, which can be more easily exfoliated by strong adsorptivity without the ceramic green sheet being damaged, has been continuously going on. Currently, porous sheets, each of which is formed by attaching a porous ultrahigh molecular weight polyethylene sheet to a mold having fine holes machined in it, are being applied to a process of stacking laminated ceramic condensers.

A porous ultrahigh molecular weight polyethylene sheet is fabricated by sintering ultrahigh molecular weight polyethylene powder using steam and then cooling and cutting the sintered body. This porous ultrahigh molecular weight polyethylene sheet can be fabricated to be relatively thick, and its surface roughness, friction coefficient and rigidity can be improved depending on the manufacturing process thereof.

However, such a porous ultrahigh molecular weight polyethylene sheet is problematic in that it is expensive to manufacture, its thickness, particle size, density and porosity are not uniform, and its pore size cannot be easily reduced because air permeability must be maintained, and thus it cannot easily keep up with slim products.

### SUMMARY OF THE INVENTION

Accordingly, the present invention has been devised to solve the above-mentioned problems, and the present invention intends to provide a porous sheet, the manufacturing cost of which can be reduced by simplifying a manufacturing process, and a method of manufacturing the same.

Further, the present invention intends to provide a porous sheet, which has high porosity and excellent surface roughness, the raw material of which can be variously selected according to product characteristics and which can minimize the damage to subjects to be adsorbed, and a method of manufacturing the same.

Further, the present invention intends to provide a porous sheet, which has high rigidity, which is not easily scratched and deformed and which has low surface resistance, and a method of manufacturing the same.

Furthermore, the present invention intends to provide a porous sheet which can be applied to various fields, and a method of manufacturing the same.

An aspect of the present invention provides a porous sheet, including a fine fiber web, wherein the fine fiber web is formed by bonding fine fibers with each other using an adhesive material.

Here, each of the fine fibers may have a diameter of 50˜5000 nm.

Further, the intersections of the fine fibers may be bonded with each other by the adhesive material.

Further, each of the fine fibers may be prepared in the form of a mixture of a polymer and the adhesive material. Further, the polymer may be at least one selected from the group consisting of polyvinylidine fluoride, polyvinyl alcohol, polyethylene terephthalate, polycarbonate, polyetherimide, polyethylene oxide, polylactic acid, cellulose, aromatic polyester, polyphosphazene, polyurethane, polyurethane-containing copolymers, cellulose acetate, cellulose acetate butyrate, cellulose acetate propionate, polyvinylidene fluoride, perfluoropolymers, polyvinyl chloride, polyvinylidene chloride, polyethyleneglycol derivatives, polyoxide, polyvinyl acetate, polystyrene, polyacrylonitrile, and polymethylmethacrylate. Further, the adhesive material may be an acrylate-based material.

Further, each of the fine fibers may be formed by attaching the adhesive material to a surface of the fine fiber made of the polymer.

Another aspect of the present invention provides a method of manufacturing a porous sheet, including: mixing a polymer solution containing a polymer with an adhesive solution containing an adhesive material to prepare a spinning solution; electrospinning the spinning solution to form fine fibers, in each of which the polymer is mixed with the adhesive material; and curing the fine fibers to form a fine fiber web in which the fine fibers are bonded with each other by the adhesive material.

Here, the amount of the polymer solution in the spinning solution may be 85˜97.5 wt %, and the amount of the adhesive solution in the spinning solution may be 2.5˜15 wt %.

Further, the diameter of the fine fiber may increase as the amount of the adhesive solution in the spinning solution increases.

Further, the amount of the adhesive material in the adhesive solution may be 30˜50 wt %.

Further, the polymer may be at least one selected from the group consisting of polyvinylidine fluoride, polyvinyl alcohol, polyethylene terephthalate, polycarbonate, polyetherimide, polyethylene oxide, polylactic acid, cellulose, aromatic polyester, polyphosphazene, polyurethane, polyurethane-containing copolymers, cellulose acetate, cellulose acetate butyrate, cellulose acetate propionate, polyvinylidene fluoride, perfluoropolymers, polyvinyl chloride, polyvinylidene chloride, polyethyleneglycol derivatives, polyoxide, polyvinyl acetate, polystyrene, polyacrylonitrile, and polymethylmethacrylate. Further, the adhesive material may be an acrylate-based material.

Further, the method may further include: performing a calendering process for pressing the fine fiber web, after the forming of the fine fiber web.

Further, the curing of the fine fibers may be performed by natural curing, thermal curing or ultraviolet (UV) curing.

Still another aspect of the present invention provides a method of manufacturing a porous sheet, including: preparing a spinning solution containing a polymer; electrospinning the spinning solution to form fine fibers, each of which is made of the polymer; spraying an adhesive solution containing an adhesive material onto the fine fibers to form fine fibers attached with the adhesive material; and curing the fine fibers attached with the adhesive material to form a fine fiber web in which the fine fibers are bonded with each other by the adhesive material.

Here, the amount of the adhesive material in the adhesive solution may be 30˜50 wt %.

Further, the polymer may be at least one selected from the group consisting of polyvinylidine fluoride, polyvinyl alcohol, polyethylene terephthalate, polycarbonate, polyetherimide, polyethylene oxide, polylactic acid, cellulose, aromatic polyester, polyphosphazene, polyurethane, polyurethane-containing copolymers, cellulose acetate, cellulose acetate butyrate, cellulose acetate propionate, polyvinylidene fluoride, perfluoropolymers, polyvinyl chloride, polyvinylidene chloride, polyethyleneglycol derivatives, polyoxide, polyvinyl acetate, polystyrene, polyacrylonitrile, and polymethylmethacrylate. Further, the adhesive material may be an acrylate-based material.

Further, the method may further include: performing a calendering process for pressing the fine fiber web, after the forming of the fine fiber web.

Further, the curing of the fine fibers may be performed by natural curing, thermal curing or ultraviolet (UV) curing.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing a fine fiber web structure constituting a porous sheet according to an embodiment of the present invention;

FIG. 2 is a flowchart showing a method of manufacturing a porous sheet according to a first embodiment of the present invention;

FIG. 3 is a flowchart showing a method of manufacturing a porous sheet according to a second embodiment of the present invention;

FIG. 4 is a view showing the diameters of fine fibers mixed with an adhesive material when the amount of an adhesive solution in a spinning solution is 7.5 wt % in the method of manufacturing a porous sheet according to the first embodiment of the present invention;

FIG. 5 is a view showing the diameters of fine fibers mixed with an adhesive material when the amount of an adhesive solution in a spinning solution is 10 wt % in the method of manufacturing a porous sheet according to the first embodiment of the present invention;

FIG. 6 is a view showing the diameters of fine fibers mixed with an adhesive material when the amount of an adhesive solution in a spinning solution is 15 wt % in the method of manufacturing a porous sheet according to the first embodiment of the present invention; and

FIG. 7 is a graph showing the tensile strengths of a fine fiber web to tensile modulus when the amounts of an adhesive solution in a spinning solution are respectively 0 wt %, 5 wt % and 15 wt % in the method of manufacturing a porous sheet according to the first embodiment of the present invention.

### DESCRIPTION OF THE PREFERRED EMBODIMENTS

The objects, features and advantages of the present invention will be more clearly understood from the following detailed description of preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

Porous Sheet

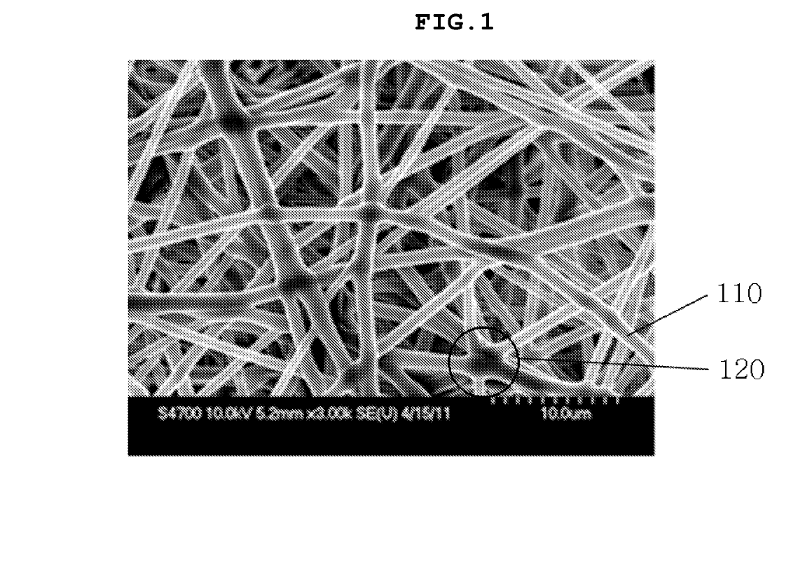

FIG. 1 is a view showing a fine fiber web structure constituting a porous sheet according to an embodiment of the present invention.

Referring to FIG. 1, the porous sheet according to an embodiment of the present invention is formed of a fine fiber web including fine fibers 110.

In this embodiment, the fine fiber 110 means a fiber having a diameter of several tens of nanometers to several thousands of nanometers. In this embodiment, the diameter of the fine fiber 110 may be 50˜5000 nm, but is not particularly limited thereto.

Further, various kinds of polymers may be used as the raw material for the fine fiber depending on the use of a product.

In this embodiment, the raw material of the fine fiber 110 may selected from the group consisting of, but are not limited to, polyvinylidine fluoride, polyvinyl alcohol, polyethylene terephthalate, polycarbonate, polyetherimide, polyethylene oxide, polylactic acid, cellulose, aromatic polyester, polyphosphazene, polyurethane, polyurethane-containing copolymers, cellulose acetate, cellulose acetate butyrate, cellulose acetate propionate, polyvinylidene fluoride, perfluoropolymers, polyvinyl chloride, polyvinylidene chloride, polyethyleneglycol derivatives, polyoxide, polyvinyl acetate, polystyrene, polyacrylonitrile, polymethylmethacrylate, and mixtures thereof. In addition, the raw material of the fine fiber 110 may be selected from commonly-used polymers, such water-polymers, oil-soluble polymers and the like.

In this embodiment, the fine fiber 110 may be formed by electrospinning. Here, electrospinning is a process of instantaneously spinning a low-viscosity polymer into a fiber using electrostatic force.

Electrospinning is characterized in that a fiber having a diameter of nanometers (nm) or micrometers (μm) can be made using a material having a diameter of millimeters (mm). Electrospinning is advantageous in that fibers having various thicknesses and properties can be formed depending on the characteristics (viscosity, surface tension, conductivity, etc.) of a spinning solution, the size of the applied potential difference, the distance between a nozzle and a collector, and the like.

For example, when a high-voltage electric field is applied to a raw material (polymer), the molecules of the raw material are conglomerated by the electric repulsive force occurring in the raw material, and thus the raw material is split into nanometer-size or micrometer-size yarns. In this case, the raw material can be split thinner as the electric field becomes stronger. When the yarns split in this way are collected without performing a weaving process, they intertwine each other, thus forming a fine fiber web.

The fine fiber web formed in this way has high porosity and excellent surface roughness because fine fibers 110 constituting the fine fiber web have a diameter of nanometers (nm) or micrometers (μm).

However, this conventional fine fiber web is problematic in that, since it is formed by intertwining fine fibers 110, it has low strength, is easily scratched and deformed, and has high surface resistance, so that it is easily damaged when it comes into contact with external materials. Therefore, in order to increase the strength thereof, a process of stabilizing this fine fiber web is additionally required.

Therefore, in this embodiment, differently from the conventional fine fiber web, in order to improve the strength of the fine fiber web, as shown in FIG. 1, the fine fiber web is formed such that it has junctions 120, which are formed using an adhesive material.

In this case, the junctions 120 mean the portions at which fine fibers 110 are bonded with each other. In other words, the junctions 120 are referred to as the intersections of the fine fibers 110 bonded with each other by the adhesive material.

In this embodiment, a naturally-curable acrylate-based material is used as the adhesive material, but is not limited thereto. In addition, a thermocurable material, an ultraviolet (UV) curable material or a polymer used as the main raw material of the fine fiber 110 may be used as the adhesive material.

In this embodiment, the fine fiber 110, although not shown in the drawings, may be a fine fiber formed by mixing a main raw material (polymer) with the adhesive material or may be a fine fiber formed by attaching the adhesive material to the surface of the fine fiber 110 made of the main raw material (polymer), but is not particularly limited thereto.

In this case, the shape of the fine fiber formed by mixing the raw material with the adhesive material or the shape of the fine fiber formed by attaching the adhesive material to the surface of the fine fiber 110 is changed depending on the manufacturing process thereof. The detailed description thereof will be explained in the following method of manufacturing a porous sheet.

As described above, since the strength of a porous sheet using the fine fiber web including the fine fibers 110 having the junctions 120 is remarkably improved, the process of stabilizing the fine fiber web is not required. Therefore, the process of manufacturing the porous sheet is simplified to decrease the manufacturing cost thereof, whereas the porosity of the porous sheet is improved to increase the adsorptivity and strippability thereof.

Further, since the porous sheet has very high rigidity, is not easily scratched and deformed, and is imparted with low surface resistance by the junctions 120 between the fine fibers 110, its treatability and workability are excellent.

The porous sheet composed of the fine fiber web according to this embodiment can be used as a porous adsorptive sheet which can be used in an adsorbing and stripping process, a vacuum adsorbing process and the like in the manufacture of glass plates for liquid crystal displays, semiconductor wafers, laminated ceramic condensers and the like.

Further, the porous sheet according to this embodiment can also be applied to a secondary battery including a cathode active material, an anode active material, an electrolyte and a separation membrane.

Here, a secondary battery is a battery which can be reused by recharging it using external energy after it has been discharged. Such a secondary battery is characterized in that it has high power density, can be high-power-discharged, and is only slightly influenced by temperature.

The secondary battery, as described above, includes the four major components of a cathode active material, an anode active material, an electrolyte and a separation membrane. Among these major components, the separation membrane serves to separate the cathode active material and the anode active material from each other, and is used as a passage for moving ions.

Like this, since the separation membrane must provide a passage for moving ions and prevent the movement of extraneous materials, its pores must be several micrometers (μm) in size.

A conventional method of manufacturing a separation membrane for secondary batteries is problematic in that, since it includes a stretching process for forming pores, usable raw materials are limited to polyolefin materials, so that the range of materials that can be selected is narrow, with the result that this conventional method is not suitable for realizing high functionality.

However, since the porous sheet of the present invention is manufactured by electrospinning, an additional process for forming pores is not required, so that materials can be freely selected. For this reason, the separation membrane manufactured using the porous sheet of the present invention has higher functionality than that of the conventional separation membrane.

Further, it is obvious that the porous sheet of the present invention can be applied to various fields in addition to the above-mentioned adsorptive sheet and separation membrane.

Method of Manufacturing Porous Sheet

### First Embodiment

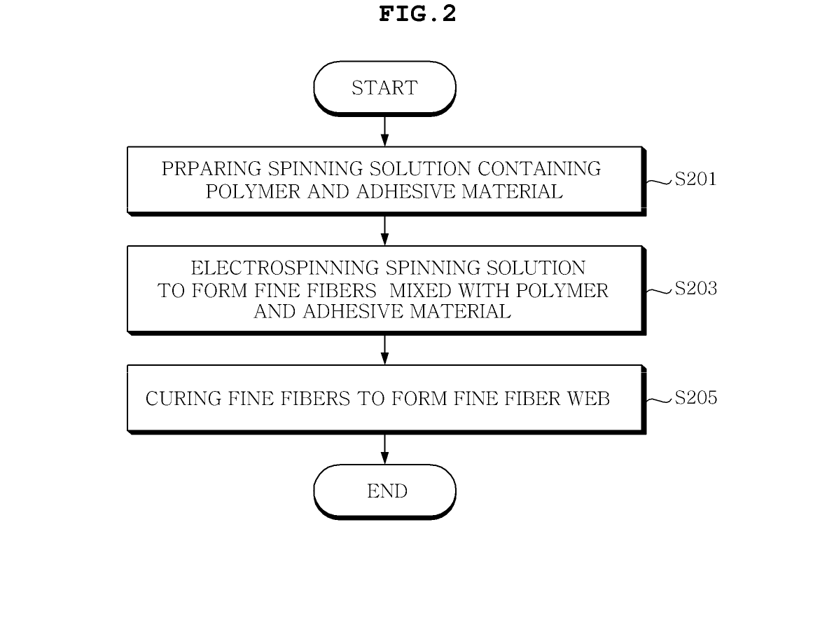

FIG. 2 is a flowchart showing a method of manufacturing a porous sheet according to a first embodiment of the present invention.

Referring to FIG. 2, first, a spinning solution is prepared by mixing a polymer solution containing a polymer with an adhesive solution containing an adhesive material (S201).

Here, the polymer, which is a major raw material of a fine fiber to be formed in a subsequent process, may be selected from the group consisting of, but is not limited to, polyvinylidine fluoride, polyvinyl alcohol, polyethylene terephthalate, polycarbonate, polyetherimide, polyethylene oxide, polylactic acid, cellulose, aromatic polyester, polyphosphazene, polyurethane, polyurethane-containing copolymers, cellulose acetate, cellulose acetate butyrate, cellulose acetate propionate, polyvinylidene fluoride, perfluoropolymers, polyvinyl chloride, polyvinylidene chloride, polyethyleneglycol derivatives, polyoxide, polyvinyl acetate, polystyrene, polyacrylonitrile, polymethylmethacrylate, and mixtures thereof. In addition, the polymer may be selected from commonly-used polymers, such water-polymers, oil-soluble polymers and the like.

In this embodiment, a naturally-curable acrylate-based material is used as the adhesive material, but is not limited thereto. In addition, a thermocurable material, an ultraviolet (UV) curable material or a polymer used as the main raw material of the above-mentioned fine fiber may be used as the adhesive material.

The polymer solution is a solution in which a polymer is dissolved in a solvent. The solvent is selected from inorganic solvents and organic solvents. A typical example of the inorganic solvent is water, and typical examples of the organic solvent may include ethers, acetone, alcohols, and the like. In this embodiment, any kind of solvent may be used.

The adhesive solution is a solution in which an adhesive material is dissolved in a solvent. In this embodiment, the amount of the adhesive material in the adhesive solution may be 30˜50 wt %, but is not particularly limited thereto. The amount thereof may also be below or above the range.

The spinning solution means a target for electrospinning. In this embodiment, the spinning solution is prepared by mixing the polymer solution with the adhesive solution such that the amount of the polymer solution in the spinning solution is 85˜97.5 wt % and the amount of the adhesive solution in the spinning solution is 2.5˜15 wt %. However, the spinning solution is not particularly limited thereto, and may also be prepared by mixing a smaller amount of the polymer solution with a large amount of the adhesive solution.

For example, it is obvious that the spinning solution be prepared by mixing the polymer solution with the adhesive solution at a mixing ratio having suitable porosity and strength depending on desired product.

Subsequently, the spinning solution prepared in this way is electrospun to form fine fibers, in each of which the polymer is mixed with the adhesive material (S203).

Here, electrospinning is a process of instantaneously spinning a low-viscosity polymer into a fiber using electrostatic force.

Electrospinning uses a high voltage in order to obtain an electrically-charged polymer jet solution or melt. This electrically-charged polymer jet solution or melt is dried or solidified in order to obtain a polymer fiber. Further, an electrode is spin-coated with the electrically-charged polymer jet solution or melt in order to attach the electrode to the surface of another collector. That is, the polymer solution adheres to the end of a capillary tube under its own inherent tension.

Spinning includes melt spinning and solution spinning. In the solution spinning, wet spinning, in which a solvent is not used when a polymer solution is spun in the form of a filament, and dry spinning, in which a solvent is used and then removed by hot air or inert gas when the polymer solution is spun in the form of a filament, are generally used.

In this embodiment, since fine fibers are formed by electrospinning the spinning solution prepared by mixing the polymer solution with the adhesive solution, each of the formed fine fibers has a form in which a polymer is mixed with an adhesive material.

As such, since each of the formed fine fibers has a form in which a polymer is mixed with an adhesive material, intersections of the fine fibers are attached to each other by the adhesive materials included in the fine fibers.

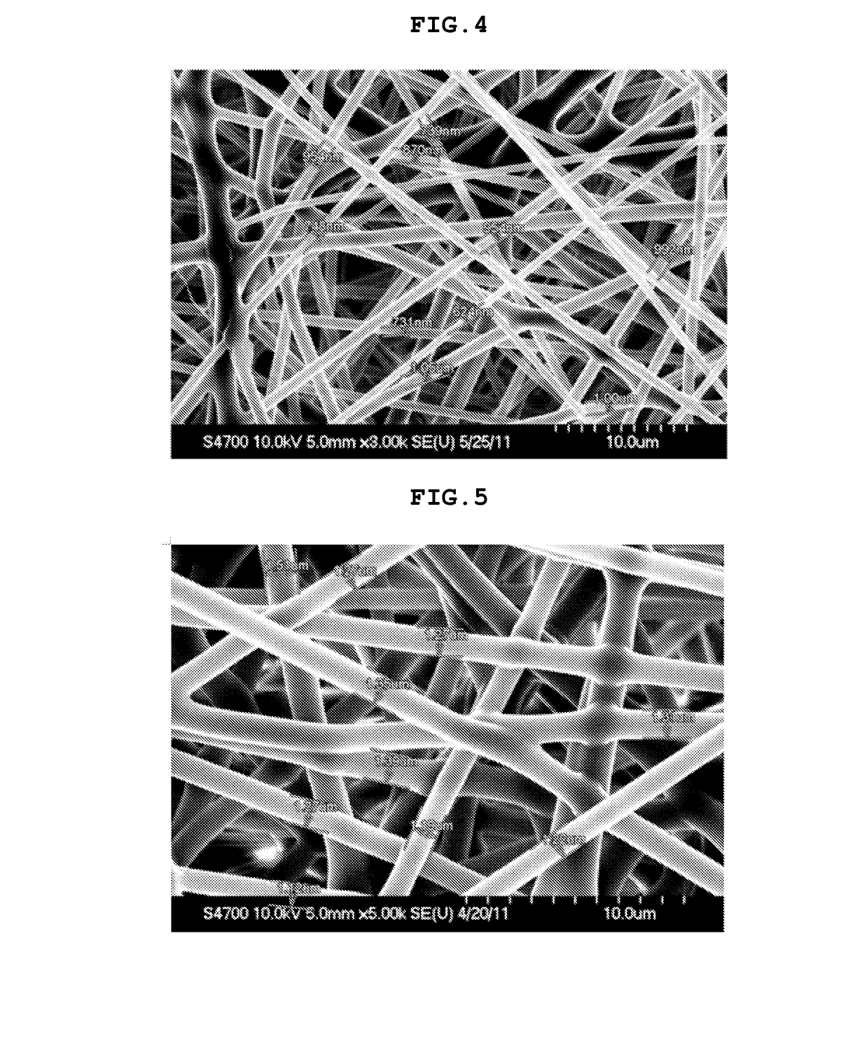

Further, according to this embodiment, the diameter of each of the fine fibers increases as the amount of the adhesive solution in the spinning solution increases. The results of the experiment thereof are shown in FIGS. 4 to 6.

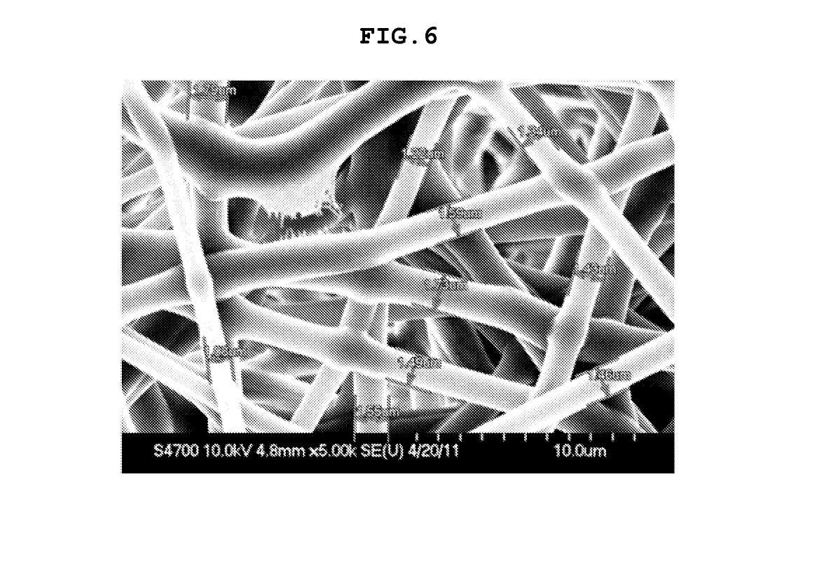

As the result of experiment, as shown in FIG. 4, the average diameter of the adhesive material-containing fine fibers formed by electrospinning the spinning solution including 7.5 wt % of the adhesive solution is 866.2 nm, and as shown in FIG. 5, the average diameter of the adhesive material-containing fine fibers formed by electrospinning the spinning solution including 10 wt % of the adhesive solution is 1284 nm, and as shown in FIG. 6, the average diameter of the adhesive material-containing fine fibers formed by electrospinning the spinning solution including 15 wt % of the adhesive solution is 1468 nm.

As described above, the diameter of the fine fiber increases as the amount of the adhesive solution in the spinning solution increases. Further, as the diameter of the fine fiber increases, the porosity of the fine fibers is improved compared to when fine fibers having a small diameter are densely entangled.

Subsequently, the entangled adhesive material-containing fine fibers are directly cured to form a fine fiber web in which the fine fibers are bonded with each other by the adhesive material (S205).

Here, the process of curing the fine fibers may be changed depending on the kind of the adhesive material, such as a naturally curable material, a thermocurable material or an ultraviolet (UV) curable material. Generally, the process of curing the fine fibers may be performed by natural curing, thermal curing or ultraviolet (UV) curing, but is not particularly limited thereto. In this embodiment, the fine fibers are naturally cured using a naturally curable acrylate-based material as the adhesive material.

That is, the fine fibers formed by mixing the polymer and the adhesive material are cured in a state in which they are entangled each other, so that the intersections of the fine fibers are attached to each other.

Therefore, the strength of the fine fiber web including the fine fibers whose intersections are attached to each other becomes remarkably high compared to the conventional fine fiber web formed by electrospinning without using the adhesive material.

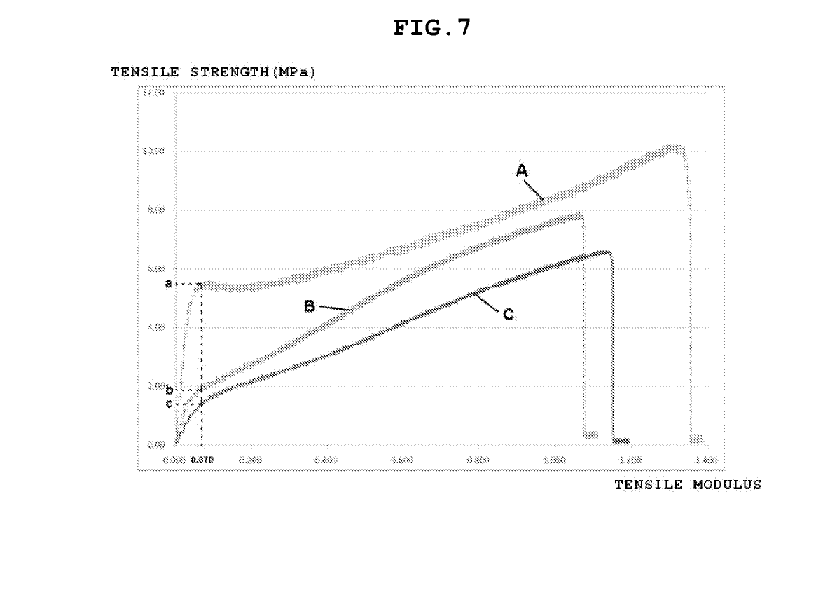

In this case, the tensile strength of the fine fiber web also increases as the amount of the adhesive solution in the spinning solution increases. The experimental data thereof are shown in the graph of FIG. 7.

In the graph of FIG. 7, the x axis represents the degree of elongation (tensile modulus), and the y axis represents the degree of resistance to elongation (tensile strength).

A represents the tensile strength of the fine fiber web to tensile modulus when the amount of the adhesive solution in the spinning solution is 15 wt %, B represents the tensile strength of the fine fiber web to tensile modulus when the amount of the adhesive solution in the spinning solution is 5 wt %, and C represents the tensile strength of the fine fiber web to tensile modulus when the amount of the adhesive solution in the spinning solution is 0 wt %.

Referring to FIG. 7, when the tensile modulus of the fine fiber web is 0.070, the tensile strengths of A, B and C are about 5.30 MPa, 1.90 MPa and 1.20 MPa, respectively. It can be ascertained from FIG. 7 that the tensile strength of the fine fiber web to the same tensile modulus remarkably increases as the amount of the adhesive solution in the spinning solution increases.

As described above, the tensile strength of the fine fiber web formed according to this embodiment can be remarkably improved compared to that of the conventional fine fiber web that does not include the adhesive material.

Subsequently, after the process of forming the fine fiber web, a process of pressing the fine fiber web may be additionally performed. The process of pressing the fine fiber web may be performed by calendering, but is not particularly limited thereto.

As such, the fine fiber web is pressed by calendaring, thus making the thickness of the fine fiber web uniform.

### Second Embodiment

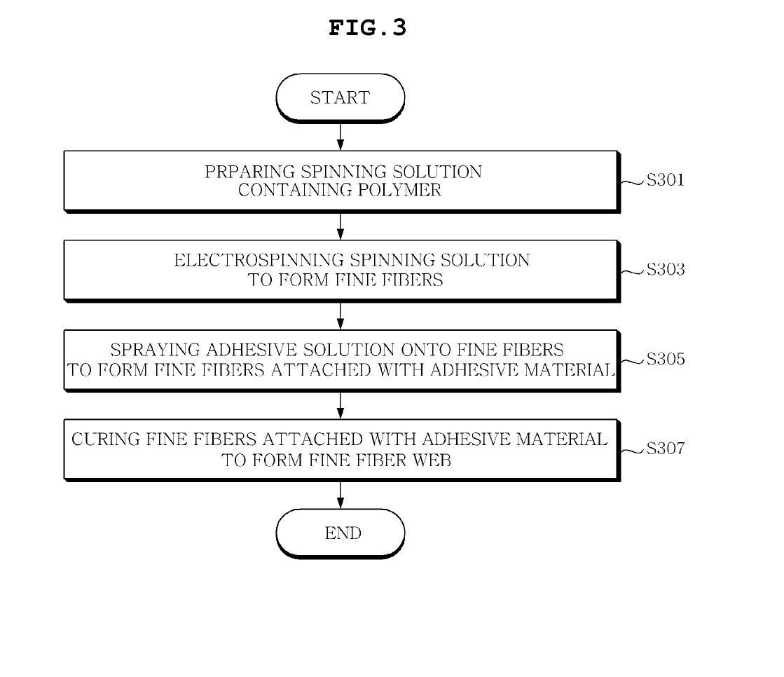

FIG. 3 is a flowchart showing a method of manufacturing a porous sheet according to a second embodiment of the present invention. Here, the description thereof that overlaps with that of the first embodiment will be omitted.

First, a spinning solution containing a polymer is prepared (S301).

In this embodiment, as described in the first embodiment, the polymer may be selected from the group consisting of, but is not limited to, polyvinylidine fluoride, polyvinyl alcohol, polyethylene terephthalate, polycarbonate, polyetherimide, polyethylene oxide, polylactic acid, cellulose, aromatic polyester, polyphosphazene, polyurethane, polyurethane-containing copolymers, cellulose acetate, cellulose acetate butyrate, cellulose acetate propionate, polyvinylidene fluoride, perfluoropolymers, polyvinyl chloride, polyvinylidene chloride, polyethyleneglycol derivatives, polyoxide, polyvinyl acetate, polystyrene, polyacrylonitrile, polymethylmethacrylate, and mixtures thereof. In addition, the polymer may be selected from commonly-used polymers, such water-polymers, oil-soluble polymers and the like.

Subsequently, fine fibers are formed by electrospinning the spinning solution (S303).

Subsequently, an adhesive solution containing an adhesive material is sprayed onto the fine fibers to form fine fibers attached with the adhesive material (S305). In this case, the method of spraying the adhesive solution is not particularly limited.

In this embodiment, a naturally-curable acrylate-based material is used as the adhesive material, but is not limited thereto. In addition, a thermocurable material, an ultraviolet (UV) curable material or a polymer used as the main raw material of the above-mentioned fine fiber may be used as the adhesive material.

Further, the adhesive solution is a solution in which an adhesive material is dissolved in a solvent. In this embodiment, the amount of the adhesive material in the adhesive solution may be 30˜50 wt %, but is not particularly limited thereto.

Subsequently, the fine fibers attached with the adhesive material are cured to form a fine fiber web in which the fine fibers are bonded with each other by the adhesive material (S307).

That is, the adhesive solution containing an adhesive material is sprayed onto the fine fibers entangled each other by a collector using electrospinning to form fine fibers attached with the adhesive material, and then the fine fibers attached with the adhesive material are cured, so that the intersections of the fine fibers are attached to each other by the adhesive material that remains behind after volatilizing a solvent from the sprayed adhesive solution.

As such, the intersections of the fine fibers are attached to each other by the adhesive material to form a fine fiber web. Therefore, the fine fiber web obtained in this way has extremely high strength compared to the conventional fine fiber web formed by electrospinning only the polymer solution.

In this case, the adhesive material may be attached to the surface of the fine fibers. That is, the fine fibers of the first embodiment are formed in the form of a mixture of a polymer and an adhesive material, whereas the fine fibers of this embodiment are formed in the form in which an adhesive material is attached to the surface of a polymer.

Further, the process of curing the fine fibers may be changed depending on the kind of adhesive material, such as a naturally curable material, a thermocurable material or an ultraviolet (UV) curable material. Generally, the process of curing the fine fibers may be performed by natural curing, thermal curing or ultraviolet (UV) curing, but is not particularly limited thereto.

Subsequently, after the process of forming the fine fiber web, a process of pressing the fine fiber web may be additionally performed. The process of pressing the fine fiber web may be performed by calendering, but is not particularly limited thereto.

As such, the fine fiber web is pressed by calendaring, thus making the thickness of the fine fiber web uniform.

Further, the porous sheets manufactured according to the first and second embodiments of the present invention can be applied to various fields in addition to the above-mentioned adsorptive sheet and separation membrane.

As described above, the porous sheet according to the present invention is advantageous in that it is composed of a fine fiber web, so that its porosity becomes high due to the characteristics of fine fibers, with the result that its adsorptivity and strippability are improved.

Further, the porous sheet according to the present invention is advantageous in that it is composed of a fine fiber web, so that it is soft and has excellent surface roughness, with the result that it can minimize the damage of the subject to be adsorbed on this porous sheet and allow the subject to be easily fixed on this porous sheet by vacuum adsorption.

Further, the porous sheet according to the present invention is advantageous in that it is manufactured by electrospinning, so that its manufacturing process is simplified, and its raw material can be variously selected depending on the characteristics of the products.

Furthermore, the method of manufacturing a porous sheet according to the present invention is advantageous in that, since the intersections of fine fibers are bonded with each other to form a fine fiber web, and the strength of the fine fiber web becomes high, so that an additional process for improving the strength of the fine fiber web can be omitted, with the result that the manufacturing process thereof is simplified, thereby reducing the manufacturing cost thereof.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Simple modifications, additions and substitutions of the present invention belong to the scope of the present invention, and the specific scope of the present invention will be clearly defined by the appended claims.

What is claimed is:

1. A porous sheet, comprising a fine fiber web, wherein the fine fiber web is formed by bonding fine fibers with each other using an adhesive material.

2. The porous sheet according to claim 1, wherein each of the fine fibers has a diameter of 50˜5000 nm.

3. The porous sheet according to claim 1, wherein intersections of the fine fibers are bonded with each other by the adhesive material.

4. The porous sheet according to claim 1, wherein each of the fine fibers is prepared in the form of a mixture of a polymer and the adhesive material.

5. The porous sheet according to claim 4, wherein the polymer is at least one selected from the group consisting of polyvinylidine fluoride, polyvinyl alcohol, polyethylene terephthalate, polycarbonate, polyetherimide, polyethylene oxide, polylactic acid, cellulose, aromatic polyester, polyphosphazene, polyurethane, polyurethane-containing copolymers, cellulose acetate, cellulose acetate butyrate, cellulose acetate propionate, polyvinylidene fluoride, perfluoropolymers, polyvinyl chloride, polyvinylidene chloride, polyethyleneglycol derivatives, polyoxide, polyvinyl acetate, polystyrene, polyacrylonitrile, and polymethylmethacrylate.

6. The porous sheet according to claim 1, wherein the adhesive material is an acrylate-based material.

7. The porous sheet according to claim 1, wherein each of the fine fibers is formed by attaching the adhesive material to a surface of the fine fiber made of the polymer.

8. A method of manufacturing a porous sheet, comprising:
mixing a polymer solution containing a polymer with an adhesive solution containing an adhesive material to prepare a spinning solution;
electrospinning the spinning solution to form fine fibers, in each of which the polymer is to mixed with the adhesive material; and
curing the fine fibers to form a fine fiber web in which the fine fibers are bonded with each other by the adhesive material.

9. The method of manufacturing a porous sheet according to claim 8, wherein an amount of the polymer solution in the spinning solution is 85˜97.5 wt %, and an amount of the adhesive solution in the spinning solution is 2.5˜15 wt %.

10. The method of manufacturing a porous sheet according to claim 9, wherein a diameter of the fine fiber increases as the amount of the adhesive solution in the spinning solution increases.

11. The method of manufacturing a porous sheet according to claim 8, wherein an amount of the adhesive material in the adhesive solution is 30˜50 wt %.

12. The method of manufacturing a porous sheet according to claim 8, wherein the polymer is at least one selected from the group consisting of polyvinylidine fluoride, polyvinyl alcohol, polyethylene terephthalate, polycarbonate, polyetherimide, polyethylene oxide, polylactic acid, cellulose, aromatic polyester, polyphosphazene, polyurethane, polyurethane-containing copolymers, cellulose acetate, cellulose acetate butyrate, cellulose acetate propionate, polyvinylidene fluoride, perfluoropolymers, polyvinyl chloride, polyvinylidene chloride, polyethyleneglycol derivatives, polyoxide, polyvinyl acetate, polystyrene, polyacrylonitrile, and polymethylmethacrylate.

13. The method of manufacturing a porous sheet according to claim 8, wherein the adhesive material is an acrylate-based material.

14. The method of manufacturing a porous sheet according to claim 8, further comprising: performing a calendaring process for pressing the fine fiber web, after the forming of the fine fiber web.

15. The method of manufacturing a porous sheet according to claim 8, the curing of the fine fibers is performed by natural curing, thermal curing or ultraviolet (UV) curing.

16. A method of manufacturing a porous sheet, comprising:
preparing a spinning solution containing a polymer;
electrospinning the spinning solution to form fine fibers, each of which is made of the polymer;
spraying an adhesive solution containing an adhesive material onto the fine fibers to form fine fibers attached with the adhesive material; and
curing the fine fibers attached with the adhesive material to form a fine fiber web in which the fine fibers are bonded with each other by the adhesive material.

17. The method of manufacturing a porous sheet according to claim 16, wherein an amount of the adhesive material in the adhesive solution is 30˜50 wt %.

18. The method of manufacturing a porous sheet according to claim 16, wherein the polymer is at least one selected from the group consisting of polyvinylidine fluoride, polyvinyl alcohol, polyethylene terephthalate, polycarbonate, polyetherimide, polyethylene oxide, polylactic acid, cellulose, aromatic polyester, polyphosphazene, polyurethane, polyurethane-containing copolymers, cellulose acetate, cellulose acetate butyrate, cellulose acetate propionate, polyvinylidene fluoride, perfluoropolymers, polyvinyl chloride, polyvinylidene chloride, polyethyleneglycol derivatives, polyoxide, polyvinyl acetate, polystyrene, polyacrylonitrile, and polymethylmethacrylate.

19. The method of manufacturing a porous sheet according to claim 16, wherein the adhesive material is an acrylate-based material.

20. The method of manufacturing a porous sheet according to claim 16, further comprising: performing a calendaring process for pressing the fine fiber web, after the forming of the fine fiber web.

21. The method of manufacturing a porous sheet according to claim 16, the curing of the fine fibers is performed by natural curing, thermal curing or ultraviolet (UV) curing.
